(19) United States
(12) Patent Application Publication
(10) Pub. No.: US 2017/0329632 A1
(43) Pub. Date: Nov. 16, 2017

(54) DEVICE SCHEDULING METHOD, TASK MANAGER AND STORAGE MEDIUM

(71) Applicant: Sanechips Technology Co., Ltd., Shenzhen, Guangdong (CN)

(72) Inventors: Chao Ma, Shenzhen (CN); Jinsong Wang, Shenzhen (CN); Wenqiong Lin, Shenzhen (CN)

(21) Appl. No.: 15/528,145

(22) PCT Filed: Apr. 28, 2015
(86) PCT No.: PCT/CN2015/077709

§ 371 Date: May 19, 2017

(30) Foreign Application Priority Data
Nov. 21, 2014 (CN) 201410675916.7

(51) Int. Cl. G06F 9/48; G06F 9/50

(52) U.S. Cl. CPC G06F 9/4881; G06F 9/5038; G06F 2209/5021

(57) ABSTRACT

Disclosed a device scheduling method. A Task Description (TD) in a task queue is read and parsed, to acquire task information of a task corresponding to the TD; and when it is determined that the task has met a starting condition and the task is a task with a highest priority among tasks which currently meet the starting condition, a preset parameter is acquired according to the task information, and the parameter is configured to a device intended to complete the task. A task manager and a storage medium is also disclosed.

### TECHNICAL FIELD

The disclosure relates to a device scheduling related technology in the field of signal processing, and in particular to a device scheduling method, a task manager and a storage medium.

### BACKGROUND

Along with continuous development of the field of wireless communications, various communication standards emerge one after another, and the phenomenon of coexistence of multiple communication systems appears. For example, at present, terminals are usually required to simultaneously support 2nd Generation/3rd Generation (2G/3G) communication standards, and the Long Term Evolution (LTE)/LTE-Advanced (LTE-A) is also becoming a standard required to be supported by terminals.

The conventional hardware-dominated Application Specific Integrated Circuit (ASIC) terminal devices are not adapted to such a situation. An ASIC device may be performance/power consumption/cost optimized for a single communication protocol implementation. However, in a multimode condition, the ASIC device may provide support for the multiple communication protocols only by adding hardware modules, which causes continuous expansion of a chip area and power consumption as well as inflexibility and very high upgrading cost.

In this context, how to interconnect multiple arithmetic devices, such as a vector processor and a hardware accelerator, to implement flexible data interaction, and how to flexibly and efficiently schedule the multiple arithmetic devices to collaboratively complete arithmetic tasks in different scenarios are crucial. At present, a widely adopted method is to schedule the multiple arithmetic devices through software scheduling and interrupt feedback by using a master processor. This method has the following problems:

1: an interrupt is high in overhead and occupies a processing capability of the master processor. This problem is particularly serious during frequent scheduling;

2: scheduling efficiency is low. The master processor has to query each starting condition of the arithmetic devices, and the efficiency of the one-by-one query is low because the processor executes instructions in series; and

3: real-time performance is poor. Since arithmetic devices run in parallel independently of each other, it is difficult for the master processor to timely discover idle states of all the devices and timely issue new tasks to the devices.

### SUMMARY

In view of this, it is intended to provide a device scheduling method, a task manager and a storage medium in embodiments of the disclosure, which may solve the problems of low device scheduling efficiency and poor real-time performance.

To this end, the technical solutions of the embodiments of the disclosure are implemented as follows.

An embodiment of the disclosure provides a device scheduling method, which may include that:

a Task Description (TD) in a task queue is read and parsed, to acquire task information of a task corresponding to the TD; and

when it is determined that the task has met a starting condition and the task is a task with a highest priority among tasks which currently meet the starting condition, a preset parameter is acquired according to the task information, and the parameter is configured to a device intended to complete the task.

In the solution, the task information may include: an Input Buffer Number (IBN), an Output Buffer Number (OBN), an Input Data Size (IDS) of the task, an Output Data Size (ODS) of the task and a Device Identity (DID); and

the operation that it is determined that the task has met the starting condition may include that: it is determined that a size of data in a buffer is not smaller than the IDS, a storage space occupied by the ODS is not larger than a storage space of the buffer and the device is in an idle or configurable state.

In the solution, the task information may include: a Parameter Address (PA) and a Burst Type (BT); and

the step that the preset parameter is acquired according to the task information, the parameter to the device intended to complete the task is configured and the device is started may include that: a clock of the device intended to complete the task is controlled to be turned on, the preset parameter is acquired according to the PA, and the parameter is configured to the device intended to complete the task according to the BT, to start the device.

In the solution, the task information may include: a configuration repetition times and a PA repetition type; and

the method may further include that: whether the starting condition of the task is met or not and whether the task has the highest priority or not are repeatedly judged according to the configuration repetition times, and every time when it is determined that the task has met the starting condition and the task is the task with the highest priority among the tasks which currently meet the starting condition, the parameter is configured to the device;

or, whether the starting condition of the task is met or not and whether the task has the highest priority or not are repeatedly judged according to the configuration repetition times, and every time when it is determined that the task has met the starting condition and the task is the task with the highest priority among the tasks which currently meet the starting condition, the parameter is read in an address incrementing manner and the read parameter is configured to the device.

In the solution, the task information may include: Atomic TD Package (ATDP) information; and

when it is determined that the TD is an Atomic TD (ATD) in an ATDP according to the ATDP information, after the step that the parameter is configured to the device intended to complete the task and the device is started, the method may further include that: when a task corresponding to a next ATD in the ATDP meets the starting condition, a parameter corresponding to the next ATD is acquired, the acquired parameter is configured to a device intended to complete the task and the device is started until processing of a last ATD in the ATDP is ended.

Another embodiment of the disclosure provides a task manager, which includes a Queue Manager (QMAN) and a Task LOADER (TLOADER).

The QMAN is configured to read and parse a TD in a task queue, so as to acquire task information of a task corresponding to the TD, and when it is determined that the task has met a starting condition and the task is a task with a highest priority among tasks which currently meet the starting condition, trigger the TLOADER; and

the TLOADER may be configured to acquire a preset parameter according to the task information and configure the parameter to a device intended to complete the task.

In the solution, the task information may include: an IBN, an OBN, an IDS, an ODS and a DID;

the QMAN may be configured to determine that a size of data in a buffer is not smaller than the IDS, a storage space occupied by the ODS is not larger than a storage space of the buffer and the device is in an idle or configurable state; and

correspondingly, the task manager may further include: a Buffer Manager (BMAN) and a Device Manager (DMAN), wherein

the BMAN may be configured to monitor a data state of the buffer and output the data state of the buffer to the QMAN; and

the DMAN may be configured to detect the state of the device and output the state of the device to the QMAN.

In the solution, the task information may include: a PA and a BT;

the TLOADER may be configured to, when a clock of the device intended to complete the task is turned on, acquire the preset parameter according to the PA, and configure the parameter to the device intended to complete the task according to the BT, to start the device; and

correspondingly, the DMAN may be configured to control the clock of the device intended to complete the task to be turned on.

In the solution, the task information may include: a configuration repetition times and a PA repetition type;

the QMAN may further be configured to repeatedly judge whether the starting condition of the task is met or not and whether the task has the highest priority or not according to the configuration repetition times, and every time when it is determined that the task has met the starting condition and the task is the task with the highest priority among the tasks which currently meet the starting condition, trigger the TLOADER; and correspondingly, the TLOADER may further be configured to repeatedly configure the parameter to the device, or read the parameter in an address incrementing manner and configure the read parameter to the device.

In the solution, the task information may include: ATDP information; and when it is determined that the TD is an ATD in an ATDP according to the ATDP information, the TLOADER may further be configured to wait until a task corresponding to a next ATD in the ATDP meets the starting condition, acquire a parameter corresponding to the next ATD, configure the acquired parameter to a device intended to complete the task and start the device until processing of a last ATD in the ATDP is ended.

Yet another embodiment of the disclosure provides a computer storage medium storing computer programs for executing the device scheduling method of the embodiments of the disclosure.

According to the device scheduling method, task manager and storage medium provided by the embodiments of the disclosure, the dedicated task manager is provided, and the task manager reads and parses the TD in the task queue to acquire the task information of the task corresponding to the TD; and when it is determined that the task has met the starting condition and the task is the task with the highest priority among the tasks which currently meet the starting condition, the preset parameter is acquired according to the task information, and the parameter is configured to the device intended to complete the task. Therefore, device scheduling is implemented by using the dedicated hardware task manager and a parameterized design, such that the problems of low efficiency, poor real-time performance and the like caused by device scheduling with software in the conventional art can be solved.

### BRIEF_DESCRIPTION OF THE DRAWINGS

FIG. 1 is a flowchart of a device scheduling method according to an embodiment of the disclosure;

FIG. 2 is a schematic diagram of a task queue according to an embodiment of the disclosure;

FIG. 3 is a schematic diagram of completely reading a task queue according to an embodiment of the disclosure;

FIG. 4 is a schematic diagram of filling a task queue according to an embodiment of the disclosure;

FIG. 5 is a schematic diagram of a bit-domain definition manner for a TD according to an embodiment of the disclosure;

FIG. 6 is a schematic diagram of a corresponding relationship between a DID and a device base address register according to an embodiment of the disclosure;

FIG. 7 is a schematic diagram of device registration according to an embodiment of the disclosure;

FIG. 8 is a schematic diagram of a buffer defined according to an embodiment of the disclosure;

FIG. 9 is a schematic diagram of transfer in an increment transfer mode according to an embodiment of the disclosure;

FIG. 10 is a schematic diagram of transfer in a fixed address transfer mode according to an embodiment of the disclosure;

FIG. 11 is a schematic diagram of transfer in a disperse address transfer mode according to an embodiment of the disclosure;

FIG. 12 is a schematic diagram of transfer in a message transfer mode according to an embodiment of the disclosure;

FIG. 13 is a schematic diagram of repeated parameter configuration according to an embodiment of the disclosure;

FIG. 14 is a schematic diagram of an ATDP according to an embodiment of the disclosure;

FIG. 15 is a schematic diagram of abstract definition of a device according to an embodiment of the disclosure;

FIG. 16 is a structure diagram of a task manager according to an embodiment of the disclosure;

FIG. 17 is a schematic diagram of a device scheduling system including a task manager according to an embodiment of the disclosure;

FIG. 18 is a schematic diagram of internal connection of a task manager supporting management of three task queues, two devices and four buffers according to an embodiment of the disclosure;

FIG. 19 is a schematic diagram of a device with two sets of control interfaces according to an embodiment of the disclosure; and

FIG. 20 is a schematic diagram of task interrupt reporting according to an embodiment of the disclosure.

### DETAILED DESCRIPTION

In an embodiment of the disclosure, a dedicated task manager is provided, and the task manager reads and parses a TD in a task queue to acquire task information of a task corresponding to the TD; and when it is determined that the task has met a starting condition and the task is a task with a highest priority among tasks which currently meet the starting condition, a preset parameter is acquired according to the task information, and the parameter is configured to a device intended to complete the task.

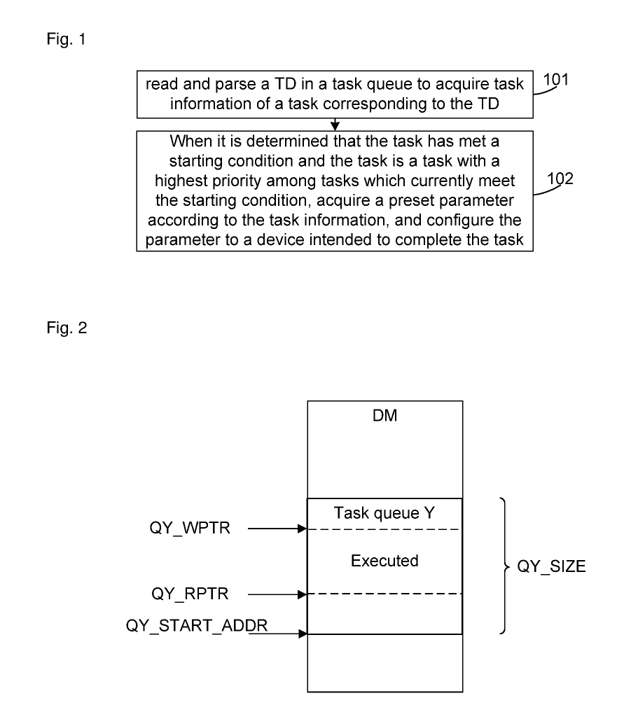

FIG. 1 is a flowchart of a device scheduling method according to an embodiment of the disclosure. As shown in FIG. 1, the device scheduling method of the embodiment of the disclosure includes the following steps.

In Step 101, a TD in a task queue is read and parsed, to acquire task information of a task corresponding to the TD.

Before the step, a dedicated task manager may be provided in advance. The task manager includes a QMAN, a BMAN, a DMAN and a TLOADER. Correspondingly, the step is implemented by the QMAN.

Before the step, the method further includes that: the QMAN controls Read Enable of the task queue.

Here, taking a random task queue Y for example, and the QMAN may control the Read Enable of the task queue through a QY_ENABLE register; and only when the task queue is Read Enabled, the QMAN may read the TD from the task queue, otherwise the

QMAN may not read the TD.

In an embodiment, before the QMAN controls the Read Enable of the task queu, the method further includes that: a processor fills TDs into the task queue, calculates task parameters and places the task parameters in a Data Memory (DM).

Here, the task queue is a queue of TDs stored in the DM. For the queue Y, a starting address and size of the queue Y in the DM may be defined through QY_START_ADDR and QY_SIZE registers, as shown in FIG. 2.

The task queue is read and written in a ring-like manner. A current reading and writing position is identified by hardware registers QY_WPTR and QY_RPTR. QY_WPTR points to a next position to be filled with a TD, and QY_RPTR points to a next position from which a TD will be read.

When filling the TDs into the task queue, the processor starts filling from the current QY_WPTR position, may sequentially fill one or more TDs at one time, then updates QY_WPTR to point to a next fillable position, and turns back to a position QY_START_ADDR to continue the filling if encountering a boundary of the task queue.

When reading the TDs in the task queue, the QMAN reads only one TD at one time, updates QY_RPTR to a next TD position after reading, and turns back to the starting position QY_START_ADDR if encountering the boundary of the task queue.

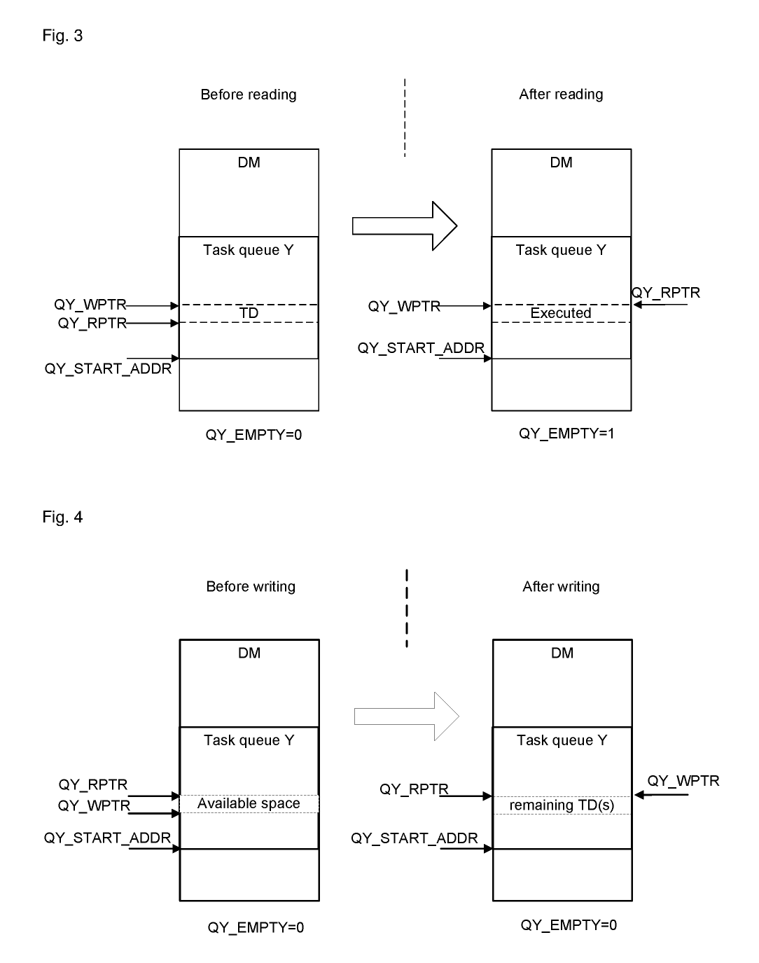

Here, after the TD is read and QY_RPTR is updated, if QY_RPTR and QY_WPTR coincide with each other, it is indicated that the queue Y is empty, and at this moment, reading of the queue is stopped, and the QMAN sets a QY_EMPTY signal to be “1”, as shown in FIG. 3.

After the processor writes the TD and updates QY_WPTR, if QY_RPTR and QY_WPTR coincide with each other and the QY_EMPTY signal is not “1”, it is indicated that the queue Y is full, and at this moment, the queue cannot be filled, otherwise an effective TD to be executed may be covered, as shown in FIG. 4.

In an embodiment, during a practical application, the processor may control the task queue to suspend at any time as desired, so that the tasks in the queue may be cleared and regulated. That is, when the tasks in the queue are to be regulated, the queue may be suspended, and QY_WPTR, QY_RPTR and the TDs in the task queue may be modified for free regulation. When the task queue is controlled to be suspended, a subsequent process for a TD which has been read from the task queue may be continued to be executed.

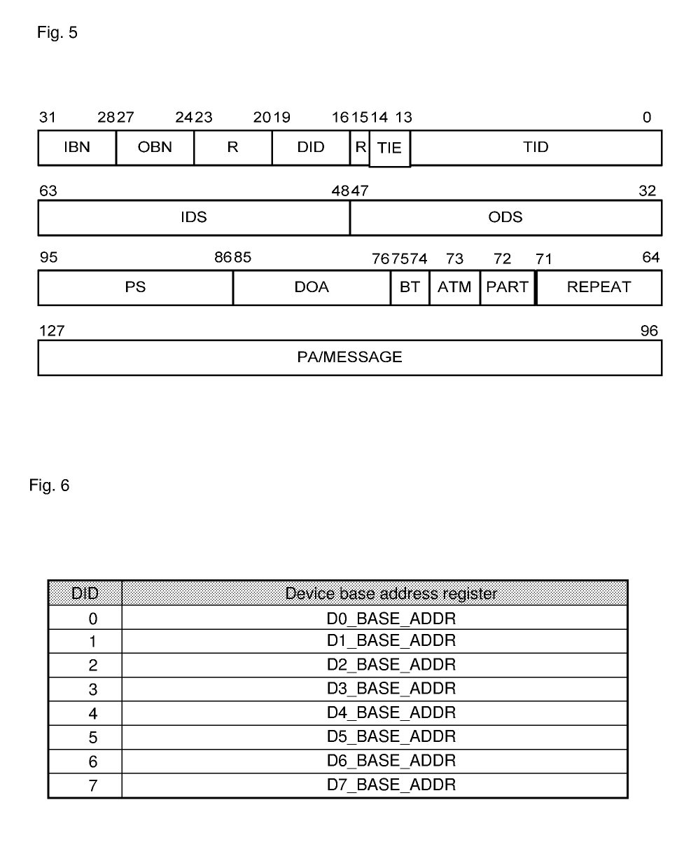

In an embodiment, the task information includes: a DID, an IBN, an OBN, an IDS, an ODS, a Task ID (TID), a PA for configuration of a device, a Device Offset Address (DOA), a Parameter Size (PS) for configuration of the device, a BT, a configuration repetition times, a task priority, Atomic Task Description Package (ATDP) information, information about whether to report an interrupt after completion of the task or not and the like. FIG. 5 is a schematic diagram of a bit-domain definition manner for a TD.

Here, functions of the DID include: registering a device to enable the device to be scheduled and managed; identifying the device which executes the task; and configuring a physical address of a control interface of the device. For example, a base address of a control interface of a device Z is configured through a device base address register DZ_BASE_ADDR, and each DID corresponds to a DZ_BASE_ADDR register, as shown in FIG. 6.

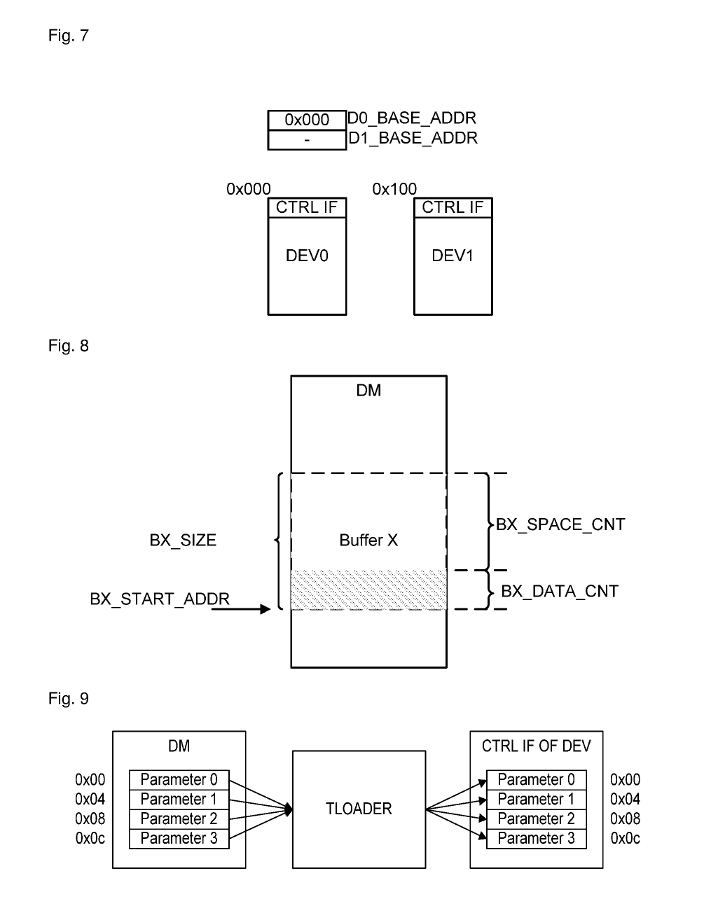

In the embodiment of the disclosure, each device to which the TLOADER configures a parameter is a device which has been registered on the DMAN. The registration refers to allocating a DID corresponding to a physical address of a control interface of the device to the device. For example, if there are two devices DEV0 and DEV1, physical addresses corresponding to their control interfaces may be 0x000 and 0x100 respectively. If DEV0 is required to be registered for scheduling, D0_BASE_ADDR may be set as the physical address of the control interface of DEV0, i.e. 0x000. If DEV1 is required to be reserved for direct scheduling by the processor, no DZ_BASE_ADDR should be set as the physical address 0x100 of the control interface of DEV1, as shown in FIG. 7.

A size of the TID may be 14 bits, so that repetition of the TID may be avoided within an enough long time. The TID may also reflect the priority of the task.

In Step 102, when it is determined that the task has met a starting condition and the task is a task with a highest priority among tasks which currently meet the starting condition, a preset parameter is acquired according to the task information, and the parameter is configured to a device intended to complete the task.

Here, the step that it is determined that the task has met the starting condition includes that:

the QMAN determines that data in a buffer is not smaller than the IDS, a storage space occupied by the ODS is not larger than a storage space in the buffer and the device is in an idle or configurable state.

Here, the buffer is arranged in the DM, and a data state of the buffer may be monitored by the Buffer Manager (BMAN) in real time. A starting address and size of a buffer X in the DM are defined through BX_START_ADDR and BX_SIZE, a size of data stored in the current buffer X is recorded through a data counter BX_DATA_CNT, and correspondingly, BX_SPACE_CNT is used to represent a remaining storage space in the buffer X, BX_SIZE=BX_DATA_CNT+BX_SPACE_CNT. FIG. 8 is a schematic diagram of a buffer defined in a DM.

When a device which executes tasks is executing a task and reading data from the buffer X, the device is a data consumer, and the value of BX_DATA_CNT may be decreased by subtracting a size of the data which has been read.

When the device which executes the tasks is executing a task and writing data into the buffer X, the device is a data producer, the value of BX_DATA_CNT may be increased by adding a size of the data which has been written, and correspondingly, BX_SPACE_CNT may be decreased.

In an embodiment, the method further includes that: the BMAN updates a size of the data in the buffer according to a preset data updating mode.

Here, the data updating mode includes: a real-time updating mode and a non-real-time updating mode. When the data updating mode is the real-time updating mode, the BMAN updates the size of the data in the buffer in real time according to a clock monitoring period of the BMAN, namely updating BX_DATA_CNT; and when the data updating mode is the non-real-time updating mode, the BMAN updates the size of the data in the buffer only when finishing executing a task, namely updating BX_DATA_C NT.

In an embodiment, the step that it is determined that the data in the buffer is not smaller than the IDS includes that: the QMAN compares the value of BX_DATA_CNT output by the BMAN with a value of the IDS, and when the value of BX_DATA_CNT is greater than or equal to the value of the IDS, the QMAN determines that the data in the buffer is not smaller than the IDS.

The step that it is determined that the storage space occupied by the ODS is not larger than the storage space in the buffer includes that: the QMAN compares a value of BX_SPACE_CNT output by the BMAN with a value of the ODS, and when the value of BX_SPACE_CNT is greater than or equal to the value of the ODS, the QMAN determines that the storage space occupied by the ODS is not larger than the storage space in the buffer.

The step that it is determined that the device is in the idle or configurable state includes: a device state request containing the DID in the task information is sent to the DMAN, and the state of the device is determined according to a value of DZ_CTRL_IF_FULL, fed back by the DMAN, corresponding to the DID. For example, if DZ_CTRL_IF_FULL=0, it is indicated that the device is in the idle or configurable state; and if DZ_CTRL_IF_FULL=1, it is indicated that the control interface of the device has been filled, and may not accept any new task.

Here, a value of the register DZ_CTRL_IF_FULL is used to judge a configurable condition of the control interface of the device Z.

When the TLOADER finishes parameter configuration for the device once, a value of a control interface counter in the TLOADER is added by 1 automatically, and when the device finishes executing the task, the value of the control interface counter is subtracted by 1 automatically. A device interface depth is usually at most 2, so that a maximum value of the control interface counter is also 2.

The register DZ_CTRL_IF_FULL is used to represent a control interface depth of the device Z, and when the value of the control interface counter is equal to DZ_CTRL_IF_DEPTH, it is indicated that the control interface of the device has been filled up, and the device may not accept any new parameter configuration, that is, DZ_CTRL_IF_FULL=1; and when the value of the control interface counter is smaller than DZ_CTRL_IF_DEPTH, it is indicated that the device has a configurable control interface(s), that is, DZ_CTRL_IF_FULL=0.

In an embodiment, when the TLOADER determines the control interface counter corresponding to the device is 0, it is indicated that the device has no task to be executed currently, and the TLOADER triggers the DMAN to control the clock of the device to be turned off.

In an embodiment, the task information includes: a PA and a BT, and the step that the preset parameter is acquired according to the task information, the parameter is configured to the device intended to complete the task and the device is started includes that:

when the clock of the device intended to complete the task is turned on, the TLOADER acquires the preset parameter according to the PA and configures the parameter to the device intended to complete the task according to the BT, to start the device to execute the task.

Correspondingly, the DMAN is further arranged to control the clock of the device intended to complete the task to be turned on.

Here, the BT includes: an increment transfer mode, a fixed address transfer mode, a disperse address transfer mode and a message transfer mode.

In the increment transfer mode, a transfer address is incremented automatically, that is, addresses of parameters read from the buffer and addresses of parameters written into the control interface of the device are sequentially incremented. FIG. 9 is a schematic diagram of transfer in an increment transfer mode.

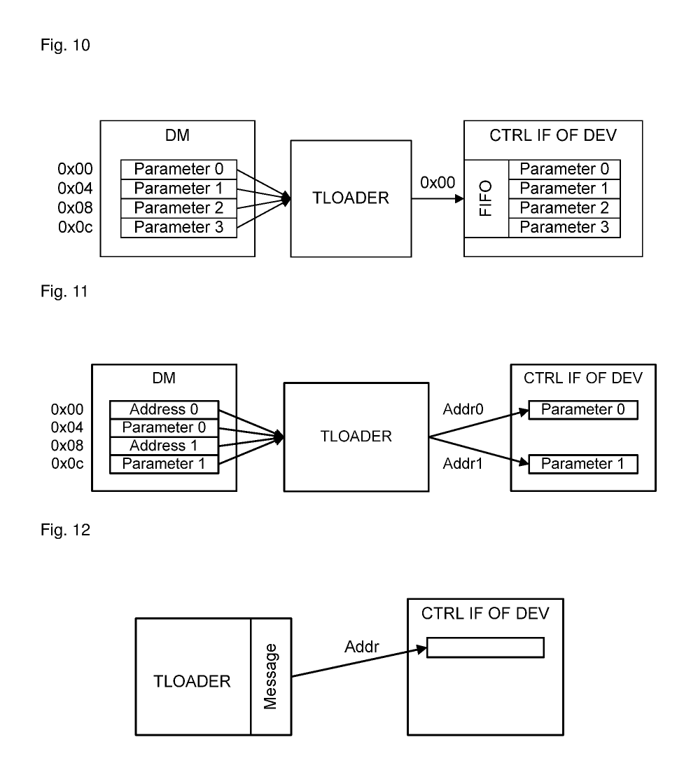

For the fixed address transfer mode, the transfer destination address is fixed and such a transfer mode is applicable to configuration of a First In First Out (FIFO) interface, and in such a transfer mode, a configuration module sequentially reads the parameters from the DM, but writes the parameters to a fixed address of the control interface of the device. FIG. 10 is a schematic diagram of transfer in a fixed address transfer mode.

In the disperse address transfer mode, a transfer address is given in a parameter. That is, a parameter includes 64 bits, of which higher 32 bits form a value of the parameter, and lower 32 bits form a destination address of the parameter. It is usually used in a condition that addresses of registers to be configured are discontinuous. In such a transfer mode, the parameter in the buffer further includes address information, and the configuration module configures the parameter according to destination address information of the parameter. FIG. 11 is a schematic diagram of transfer in a disperse address transfer mode.

The message transfer mode is to transfer a 32-bit message constant. In such a transfer mode, the configuration module does not need to read the configuration parameter from the buffer, and instead, directly configures the 32-bit constant to the DOA corresponding to the DID. Here, the 32-bit constant is a 32-bit constant for multiplexing PAs of TDs. FIG. 12 is a schematic diagram of transfer in a message transfer mode.

In an embodiment, the task information includes: a configuration repetition times and a PA repetition type, the TD is a Repeat Task Descriptor (RTD), and the method further includes that:

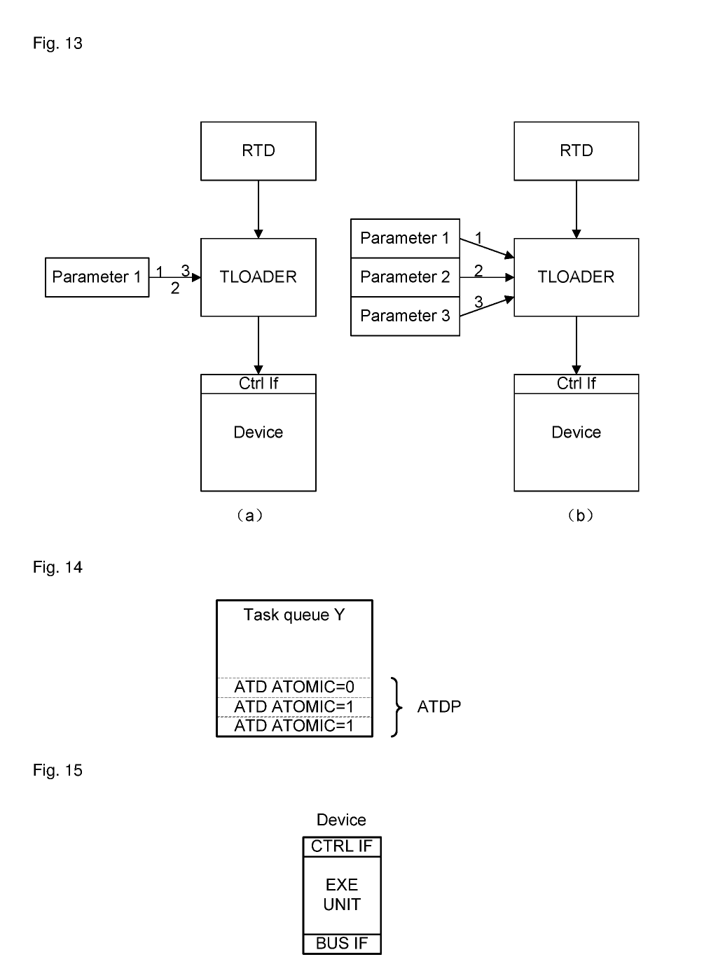

It is repeatedly judged whether the starting condition of the task is met or not and whether the task has the highest priority or not according to the configuration repetition times, and every time when it is determined that the task has met the starting condition and the task is the task with the highest priority among the tasks which currently meet the starting condition, the parameter is configured to the device, as shown in FIG. 13(a);

or, it is repeatedly judged whether the starting condition of the task is met or not and whether the task has the highest priority or not according to the configuration repetition times, and every time when it is determined that the task has met the starting condition and the task is the task with the highest priority in the tasks which currently meet the starting condition, the parameter is read in an address incrementing manner and the read parameter is configured to the device, as shown in FIG. 13(b).

A REPEAT field of the TD is used to set an execution frequency of the task, and when the repetition frequency is N, it indicates that task has been executed for N+1 times.

A PART field of the TD is used to set the PA repetition type. Here, the PA repetition type includes: repeated parameter reading and parameter reading in the address incrementing manner, wherein repeated parameter reading refers to reading the same parameter for multiple times for configuring it to the device; and parameter reading in the address incrementing manner refers to reading the parameter in a manner of incrementing each address at a fixed PS interval and configuring the read parameter to the device.

In an embodiment, the task information includes: ATDP information; and when the QMAN determines that the TD is an ATD in an ATDP according to the ATDP information, after the step that the parameter is configured to the device intended to complete the task and starting the device, the method further includes that:

when a task corresponding to a next ATD in the ATDP meets the starting condition, the QMAN starts the TLOADER, acquires a parameter corresponding to the next ATD, configures the acquired parameter to a device intended to complete the task and starts the device until processing of a last ATD in the ATDP is ended. In such a manner, tasks in the ATDP may be continuously executed without being interrupted by a high-priority task outside the ATDP.

Here, an ATOMIC field in the TD is used to implement setting of the ATDP. If the ATDP includes totally N ATDs, ATOMIC bits in the first N−1 TDs are set to be 1, and an ATOMIC bit of the last TD is set to be 0 to indicate that the TD is the last ATD in the ATDP; and the ATDs in the ATDP are TDs in the same task queue. FIG. 14 is a schematic diagram of definition of an ATDP.

In an embodiment, the task information includes: information about whether to report the interrupt after completion of the task or not, the TID, the configuration repetition times and the PA repetition type; and when it is determined according to the task information that the configuration repetition times is not zero and the interrupt is required to be reported after completion of the task, the method further includes that: the DMAN reports the interrupt every time when a task is completed.

Here, a TIE bit in the TD is used to set whether the interrupt is generated after completion of the current task or not. For example: when it is determined that the configuration repetition times in the task information is not zero and the TIE bit is set to be “1”, the DMAN may report the interrupt every time when a task is completed.

Since time lengths required for task execution of each device are different, a task which is executed earlier may not be completed earlier. In order to identify a task after which a current interrupt is generated, when the TLOADER specifies a device for executing a task, the DMAN may store a TID and TIE of the task. If determining a value of the TIE corresponding to the task is 1, the DMAN adds the corresponding TID into an interrupt TID FIFO. When execution of the task is completed, the DMAN may report an interrupt as long as the interrupt TID FIFO is not empty. When the reported interrupt is received by the processor, the processor may read the TID in the interrupt TID FIFO to determine which task generates the interrupt.

In the embodiment of the disclosure, the device refers to any hardware component with a certain function.

An abstract device includes: a control interface, through which control of device parameter configuration, start reset and the like may be implemented; an execution unit, which parses a parameter configured from the control interface to realize a certain execution function; and a bus interface, through which the device accesses a DM, reads input data required for task execution and outputs an execution result. FIG. 15 is a schematic diagram of abstract definition for a device.

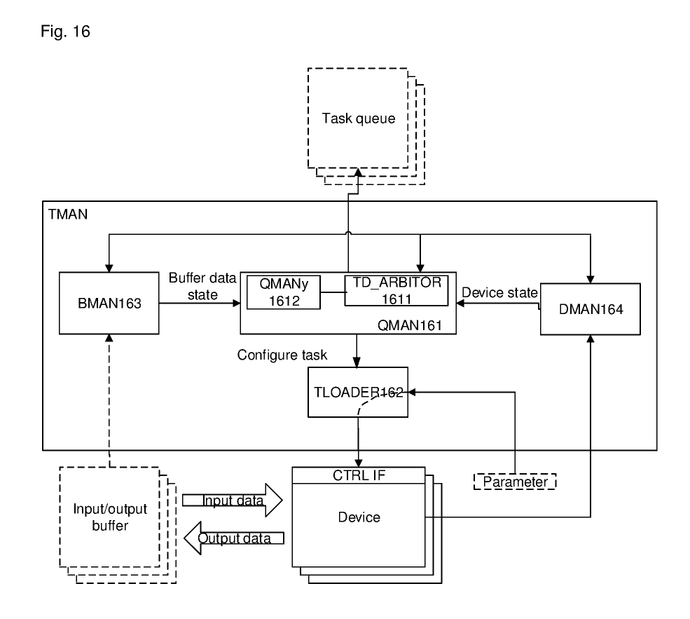

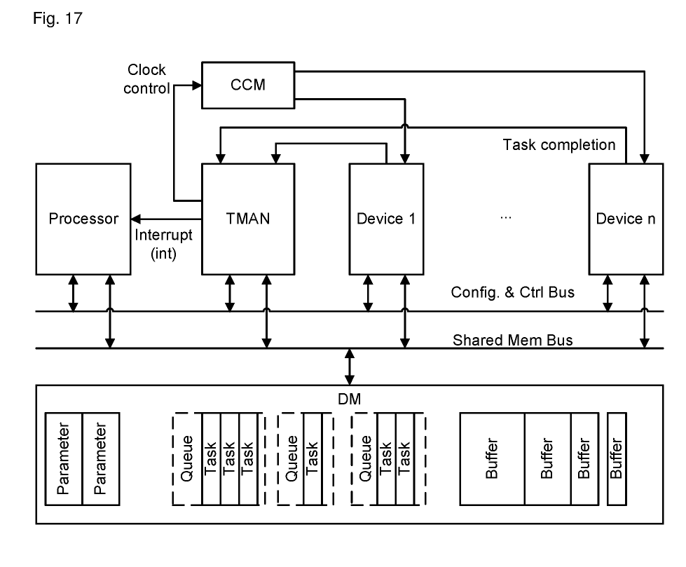

FIG. 16 is a structure diagram of a task manager according to an embodiment of the disclosure and FIG. 17 is a schematic diagram of a device scheduling system employing a task manager according to an embodiment of the disclosure. As shown in FIGS. 16 and 17, the task manager of the embodiment of the disclosure structurally includes: a QMAN 161 and a TLOADER 162.

The QMAN 161 is arranged to read and parse a TD in a task queue, to acquire task information of a task corresponding to the TD, and when it is determined that the task has met a starting condition and the task is a task with a highest priority among tasks which currently meet the starting condition, trigger the TLOADER 162.

The TLOADER 162 is arranged to acquire a preset parameter according to the task information and configure the parameter to a device intended to complete the task.

In an embodiment, the QMAN 161 is further arranged to control Read Enable of the task queue. When the queue is a queue Y, the QMAN 161 may control Read Enable of the task queue through a QY_ENABLE register; and only when the task queue is Read Enabled, the QMAN 161 may read the TD from the task queue, otherwise the QMAN 161 may not read the TD.

Correspondingly, in the device scheduling system shown in FIG. 17, a processor is arranged to fill TDs into the task queue, calculate task parameters and place the task parameters in a DM. In the device scheduling system shown in FIG. 17, the processor, the task manager and the device may work in parallel.

Here, the task queue is a queue of TDs stored in the DM. For the queue Y, a starting address and size of the queue Y in the DM may be defined through registers QY_START_ADDR and QY_SIZE, as shown in FIG. 2.

The task queue is read and written in a ring-like manner. A current reading and writing position is identified by hardware registers QY_WPTR and QY_RPTR. QY_WPTR points to a next position to be filled with a TD, and QY_RPTR points to a next position from which a TD will be read.

When filling the TDs into the task queue, the processor starts filling from the current QY_WPTR position, may sequentially fill one or more TDs at one time, then updates QY_WPTR to point to a next fillable position, and turns back to a position QY_START_ADDR to continue the filling if encountering a boundary of the task queue.

When reading the TDs in the task queue, the QMAN 161 reads only one TD at one time, updates QY_RPTR to a next TD position after reading, and turns back to the starting position QY_START_ADDR if encountering the boundary of the task queue.

Here, after the TD is read and QY_RPTR is updated, if QY_RPTR and QY_WPTR coincide with each other, it is indicated that the queue Y is empty, and at this moment, reading of the queue is stopped, and the QMAN sets a QY_EMPTY signal to be “1”, as shown in FIG. 3.

After the processor writes the TD and updates QY_WPTR, if QY_RPTR and QY_W_PTR coincide with each other and the QY_EMPTY signal is not “1”, it is indicated that the queue Y is full, and at this moment, the queue cannot be filled, otherwise an effective TD to be executed may be covered, as shown in FIG. 4.

In an embodiment, during a practical application, the QMAN 161 is further configured to control the task queue to be suspended at any time as desired, so that the tasks in the queue may be cleared and regulated. That is, when the processor is required to regulate the tasks in the queue, the queue may be suspended, and QY_WPTR, QY_RPTR and the TDs in the task queue may be modified for free regulation. When the task queue is controlled to be suspended, a subsequent process for a TD which has been read from the task queue may be continued to be executed.

In an embodiment, the task information includes: an IBN, an OBN, an IDS, an ODS and a DID.

The QMAN 161 is configured to determine that data in a buffer is not smaller than the IDS, a storage space occupied by the ODS is not larger than a storage space in the buffer and the device is in an idle or configurable state.

Correspondingly, the task manager further includes: a BMAN 163 and a DMAN 164.

The BMAN 163 is arranged to monitor a data state of the buffer and output the data state of the buffer to the QMAN 161.

The DMAN 164 is arranged to detect the state of the device and output the state of the device to the QMAN 161.

Here, the buffer is arranged in the DM, and the BMAN monitors the data state of the buffer in real time. A starting address and size of a buffer X in the DM are defined through BX_START_ADDR and BX_SIZE, a size of data stored in the current buffer X is recorded through a data counter BX_DATA_CNT, and correspondingly, BX_SPACE_CNT is used to represent a remaining storage space in the buffer X, BX_SIZE=BX_DATA_CNT+BX_SPACE_CNT. FIG. 8 is a schematic diagram of a buffer defined in a DM.

When a device which executes tasks is executing a task and reading data from the buffer X, the device is a data consumer, and the value of BX_DATA_CNT may be decreased by subtracting a size of the data which has been read.

When the device which executes the tasks is executing a task and writing data into the buffer X, the device is a data producer, the value of BX_DATA_CNT may be increased by adding a size of the data which has been written, and correspondingly, BX_SPACE_CNT may be decreased.

Functions of the DID include: registering a device to enable the device to be scheduled and managed; identifying the device which executes the task; and configuring a physical address of a control interface of the device. For example, a base address of a control interface of a device Z is configured through a device base address register DZ_BASE_ADDR, and each DID corresponds to a DZ_BASE_ADDR register, as shown in FIG. 6.

In the embodiment of the disclosure, each device scheduled by the task manager is a device which has been registered on the DMAN 164. The registration refers to allocating a DID corresponding to a physical address of a control interface of the device to the device. For example, if there are two devices DEV0 and DEV1, and physical addresses corresponding to their control interfaces may be 0x000 and 0x100 respectively. If DEV0 is required to be registered for scheduling, D0_BASE_ADDR may be set as the physical address of the control interface of DEV0, i.e. 0x000. If DEV1 is required to be reserved for direct scheduling by the processor, no DZ_BASE_ADDR should be set as the physical address 0x100 of the control interface of DEV1, as shown in FIG. 7. That is, the task manager in the embodiment of the disclosure may only schedule a device in a registered state, and scheduling of an unregistered device or a device in a deregistered state may be executed by the processor.

In an embodiment, the QMAN 161 includes: an arbitrator (TD_ARBITOR) 1611 and at least one sub queue manager QMANy 1612. The QMANy 1612 is configured to, when it is determined that the task meets the starting condition, trigger the arbitrator 1611 to judge a priority of the task, and when the arbitrator 1611 determines that the task is the task with the highest priority among the tasks which currently meet the starting condition, trigger the TLOADER 162. FIG. 18 is a diagram of internal connection of a task manager supporting management of three task queues, two devices and four buffers.

In an embodiment, that the QMAN 161 determines that a size of the data in the buffer is not smaller than the IDS includes that: the QMAN 161 compares the value of BX_DATA_CNT output by the BMAN 163 with a value of the IDS, and when the value of BX_DATA_CNT is greater than or equal to the value of the IDS, determine that the data in the buffer is not smaller than the IDS.

That the QMAN 161 determines that the storage space occupied by the ODS is not larger than the storage space in the buffer includes that: the QMAN 161 compares magnitudes of a value of BX_SPACE_CNT output by the BMAN 163 and a value of the ODS, and when the value of BX_SPACE_CNT is greater than or equal to the value of the ODS, determine that the storage space occupied by the ODS is not larger than the storage space in the buffer.

That the QMAN 161 determines that the device is in the idle or configurable state includes that: the QMAN 161 sends a device state request containing the DID in the task information to the DMAN 164, and determines the state of the device according to a value of DZ_CTRL_IF_FULL, fed back by the DMAN 164, corresponding to the DID. For example: if DZ_CTRL_IF_FULL=0, it is indicated that the device is in the idle or configurable state; and if DZ_CTRL_IF_FULL=1, it is indicated that the control interface of the device has been filled, and may not accept any new task.

Here, a value of the register DZ_CTRL_IF_FULL is used to judge a configurable condition of the control interface of the device Z.

When the TLOADER 162 finishes parameter configuration for the device once, a value of a control interface counter in the TLOADER is added by 1 automatically, and when the device finishes executing the task, the value of the control interface counter is subtracted by 1 automatically. A device interface depth is usually at most 2, so that a maximum value of the control interface counter is also 2.

The register DZ_CTRL_IF_FULL is used to represent a control interface depth of the device Z, and when the value of the control interface counter is equal to DZ_CTRL_IF_DEPTH, it is indicated that the control interface of the device has been filled up, and the device may not accept any new parameter configuration, that is, DZ_CTRL_IF_FULL=1; and when the value of the control interface counter is smaller than DZ_CTRL_IF_DEPTH, it is indicated that the device has a configurable control interface(s), that is, DZ_CTRL_IF_FULL=0.

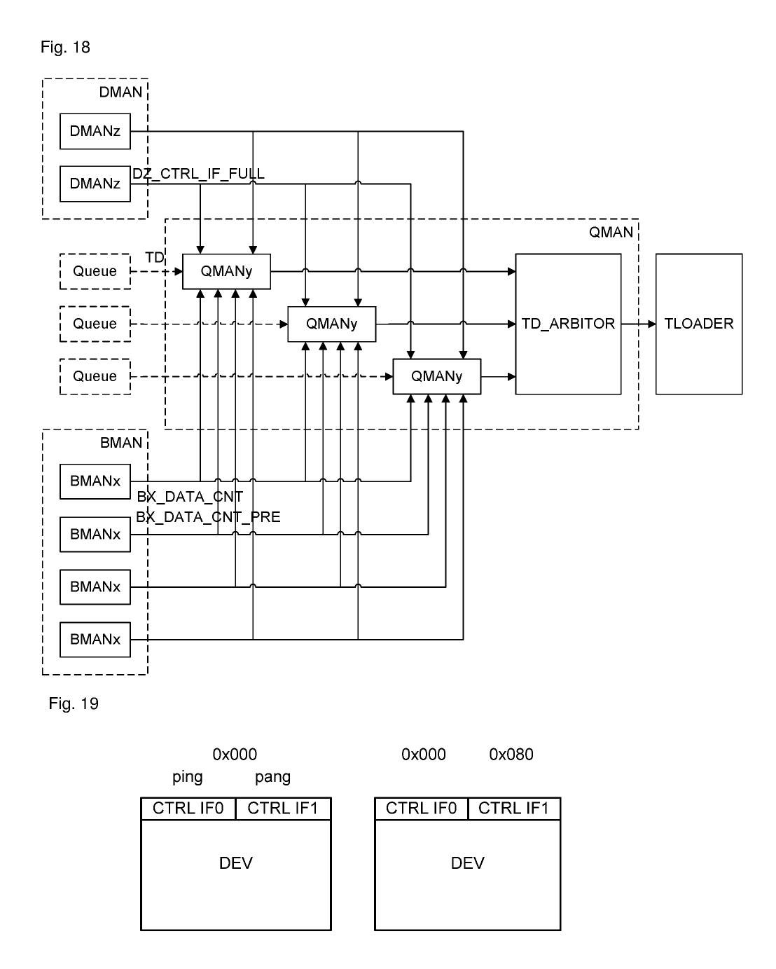

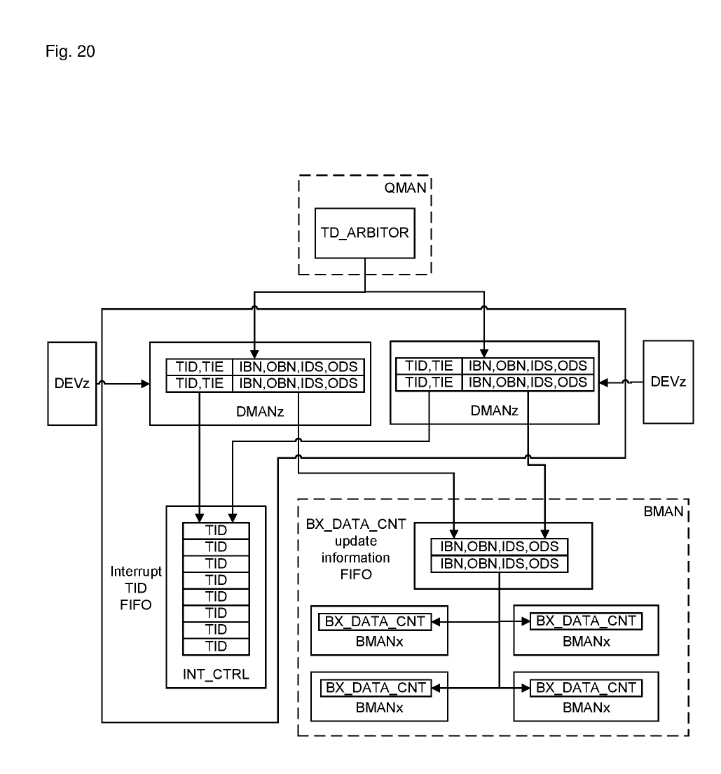

When it is expected that parameter configuration and execution of the task are executed in parallel to enable the TLOADER to configure a parameter of a next task to the control interface when the device is executing a current task, the device may support two sets of control interfaces. Physical addresses of the two sets of control interfaces may be multiplexed for ping-pong control inside the device, and may also correspond to different offsets of the same physical address of the device. As shown in FIG. 19, it is unnecessary to set more than two sets of control interfaces.

In an embodiment, the BMAN 163 is further arranged to update a size of the data in the buffer according to a preset data updating mode.

Here, the data updating mode includes: a real-time updating mode and a non-real-time updating mode. When the data updating mode is the real-time updating mode, the BMAN 163 updates the size of the data in the buffer in real time according to own clock monitoring period, namely updating BX_DATA_CNT; and when the data updating mode is the non-real-time updating mode, the BMAN 163 updates the size of the data in the buffer only when finishing executing a task, namely updating BX_DATA_C NT.

In an embodiment, the task information includes: a PA and a BT; the TLOADER 162 is arranged to, when the clock of the device intended to complete the task is on, acquire the preset parameter according to the PA, configure the parameter to the device intended to complete the task according to the BT and trigger the DMAN 164 to control the clock of the device to be turned on to start the device; and

correspondingly, the DMAN is further arranged to control the clock of the device intended to complete the task to be turned on.

Here, the BT includes: an increment transfer mode, a fixed address transfer mode, a disperse address transfer mode and a message transfer mode.

In an embodiment, the task information includes: a configuration repetition times and a PA repetition type, and the TLOADER 162 is further arranged to repeatedly configure the parameter to the device according to the configuration repetition times,

or, read the parameter in an address incrementing manner according to the configuration repetition times and configure the read parameter to the device.

Here, a REPEAT field of the TD is used to set an execution frequency of the task, and when the repetition frequency is N, it indicates that task has been executed for N+1 times.

A PART field of the TD is used to set the PA repetition type. Here, the PA repetition type includes: a repeated parameter reading and parameter reading in the address incrementing manner, wherein repeated parameter reading refers to reading the same parameter for multiple times for configuring it to the device; and parameter reading in the address incrementing manner refers to reading the parameter in a manner of incrementing each address at a fixed PS interval and configuring the read parameter to the device.

In an embodiment, the task information includes: ATDP information; and when it is determined that the TD is an ATD in an ATDP according to the ATDP information, the TLOADER 162 is further configured to wait until a task corresponding to a next ATD in the ATDP meets the starting condition, acquire a parameter corresponding to the next ATD, configure the acquired parameter to a device intended to complete the task and start the device until processing of a last ATD in the ATDP is ended. In such a manner, tasks in the ATDP may be continuously executed without being interrupted by a high-priority task outside the ATDP.

Here, an ATOMIC field in the TD is used to implement setting of the ATDP. If the ATDP includes totally N ATDs, ATOMIC bits in the first N−1 TDs are set to be 1, and an ATOMIC bit of the last TD is set to be 0 to indicate that the TD is the last ATD in the ATDP; and the ATDs in the ATDP are TDs in the same task queue.

In an embodiment, the TLOADER 162 is further arranged to, when it is determined that the control interface counter corresponding to the device is zero, trigger the DMAN 164 to control the clock of the device to be turned off.

In an embodiment, the task information includes: information about whether to report an interrupt after completion of the task or not, a TID, the configuration repetition times and the PA repetition type.

The DMAN 164 is further arranged to, when the configuration repetition times is not zero and the interrupt is required to be reported after completion of the task, report the interrupt every time when a task is completed.

Since time lengths required for task execution of each device are different, a task which is executed earlier may not be completed earlier. In order to identify a task after which a current interrupt is generated, when the TLOADER specifies a device for executing a task, the DMAN may store a TID and TIE of the task. If determining a value of the TIE corresponding to the task is 1, the DMAN adds the corresponding TID into an interrupt TID FIFO. When execution of the task is completed, the DMAN may report an interrupt as long as the interrupt TID FIFO is not empty. When the reported interrupt is received by the processor, the processor may read the TID in the interrupt TID FIFO to determine which task generates the interrupt.

In the embodiment of the disclosure, the device refers to any hardware component with a certain function.

An abstract device includes: a control interface, through which control of device parameter configuration, start reset and the like may be implemented; an execution unit, which parses a parameter configured from the control interface to realize a certain execution function; and a bus interface, through which the device accesses a DM, reads input data required for task execution and outputs an execution result. FIG. 15 is a schematic diagram of abstract definition for a device.

The QMAN, TLOADER, BMAN and DMAN disclosed in the embodiment of the disclosure may all be implemented through a processor, and of course, may also be implemented through specific logical circuits, wherein the processor may be a processor in a mobile terminal or a server, and during a practical application, the processor may be a Central Processing Unit (CPU), a Micro Processing Unit (MPU), a Digital Signal Processor (DSP), a Field-Programmable Gate Array (FPGA) or the like.

In the embodiments of the disclosure, when being implemented in form of software function module and sold or used as an independent product, the device scheduling method may also be stored in a computer-readable storage medium. Based on such an understanding, the technical solutions of the embodiments of the disclosure substantially or parts making contributions to the conventional art may be embodied in form of software product, and the computer software product is stored in a storage medium, including a plurality of instructions configured to enable a computer device (which may be a personal computer, a server, a network device or the like) to execute all or part of the method in each embodiment of the disclosure. The abovementioned storage medium includes: various media capable of storing program codes such as a U disk, a mobile hard disk, a Read-Only Memory (ROM), a magnetic disk or an optical disk. Therefore, the embodiments of the disclosure are not limited to any specific hardware and software combination.

Correspondingly, the embodiments of the disclosure further provide a computer storage medium, in which a computer program is stored, the computer program being configured to execute the device scheduling method of the embodiments of the disclosure.

The above is only the preferred embodiment of the disclosure and not intended to limit the scope of protection of the disclosure.

1. A device scheduling method, comprising:
reading and parsing a Task Description (TD) in a task queue, to acquire task information of a task corresponding to the TD; and
when it is determined that the task has met a starting condition and the task is a task with a highest priority among tasks which currently meet the starting condition, acquiring a preset parameter according to the task information, and configuring the parameter to a device intended to complete the task.

2. The method according to claim 1, wherein the task information comprises: an Input Buffer Number (IBN), an Output Buffer Number (OBN), an Input Data Size (IDS) of the task, an Output Data Size (ODS) of the task and a Device Identity (DID); and
determining that the task has met the starting condition comprises: determining that a size of data in a buffer is not smaller than the IDS, a storage space occupied by the ODS is not larger than a storage space of the buffer and the device is in an idle or configurable state.

3. The method according to claim 1, wherein the task information comprises: a Parameter Address (PA) and a Burst Type (BT); and
acquiring the preset parameter according to the task information, configuring the parameter to the device intended to complete the task and starting the device comprises: controlling a clock of the device intended to complete the task to be turned on, acquiring the preset parameter according to the PA, and configuring the parameter to the device intended to complete the task according to the BT, to start the device.

4. The method according to claim 1, wherein the task information comprises: a configuration repetition times and a PA repetition type; and the method further comprises:
repeatedly judging whether the starting condition of the task is met or not and whether the task has the highest priority or not according to the configuration repetition times, and every time when it is determined that the task has met the starting condition and the task is the task with the highest priority among the tasks which currently meet the starting condition, configuring the parameter to the device;
or, repeatedly judging whether the starting condition of the task is met or not and whether the task has the highest priority or not according to the configuration repetition times, and every time when it is determined that the task has met the starting condition and the task is the task with the highest priority among the tasks which currently meet the starting condition, reading the parameter in an address incrementing manner and configuring the read parameter to the device.

5. The method according to claim 1, wherein the task information comprises: Atomic TD Package (ATDP) information; and
when it is determined that the TD is an Atomic TD (ATD) in an ATDP according to the ATDP information, after configuring the parameter to the device intended to complete the task and starting the device, the method further comprises:
waiting until a task corresponding to a next ATD in the ATDP meets the starting condition, acquiring a parameter corresponding to the next ATD, configuring the acquired parameter to a device intended to complete the task and starting the device until processing of a last ATD in the ATDP is ended.

6. A task manager, comprising: a Queue Manager (QMAN) and a Task Loader (TLOADER), wherein
the QMAN is configured to read and parse a Task Description (TD) in a task queue, so as to acquire task information of a task corresponding to the TD, and when it is determined that the task has met a starting condition and the task is a task with a highest priority among tasks which currently meet the starting condition, trigger the TLOADER; and
the TLOADER is configured to acquire a preset parameter according to the task information and configure the parameter to a device intended to complete the task.

7. The task manager according to claim 6, wherein the task information comprises: an Input Buffer Number (IBN), an Output Buffer Number (OBN), an Input Data Size (IDS) of the task, an Output Data Size (ODS) of the task and a Device Identity (DID);
the QMAN is configured to determine that a size of data in a buffer is not smaller than the IDS, a storage space occupied by the ODS is not larger than a storage space of the buffer and the device is in an idle or configurable state; and
correspondingly, the task manager further comprises: a Buffer Manager (BMAN) and a Device Manager (DMAN), wherein
the BMAN is configured to monitor a data state of the buffer and output the data state of the buffer to the QMAN; and
the DMAN is configured to detect the state of the device and output the state of the device to the QMAN.

8. The task manager according to claim 7, wherein the task information comprises: a Parameter Address (PA) and a Burst Type (BT);
the TLOADER is configured to, when a clock of the device intended to complete the task is turned on, acquire the preset parameter according to the PA, and configure the parameter to the device intended to complete the task according to the BT, to start the device; and
correspondingly, the DMAN is further configured to control the clock of the device intended to complete the task to be turned on.

9. The task manager according to claim 6, wherein the task information comprises: a configuration repetition times and a PA repetition type;
the QMAN is further configured to repeatedly judge whether the starting condition of the task is met or not and whether the task has the highest priority or not according to the configuration repetition times, and every time when it is determined that the task has met the starting condition and the task is the task with the highest priority among the tasks which currently meet the starting condition, trigger the TLOADER; and
correspondingly, the TLOADER is further configured to repeatedly configure the parameter to the device, or read the parameter in an address incrementing manner and configure the read parameter to the device.

10. The task manager according to claim 6, wherein the task information comprises: Atomic TD Package (ATDP) information; and
when it is determined that the TD is an Atomic TD (ATD) in an ATDP according to the ATDP information, the TLOADER is further configured to wait until a task corresponding to a next ATD in the ATDP meets the starting condition, acquire a parameter corresponding to the next ATD, configure the acquired parameter to a device intended to complete the task and start the device until processing of a last ATD in the ATDP is ended.

11. A non-transitory computer storage medium, storing computer-executable instructions for executing a device scheduling method, comprising:
reading and parsing a Task Description (TD) in a task queue, to acquire task information of a task corresponding to the TD; and
when it is determined that the task has met a starting condition and the task is a task with a highest priority among tasks which currently meet the starting condition, acquiring a preset parameter according to the task information, and configuring the parameter to a device intended to complete the task.

12. The non-transitory computer storage medium according to claim 11, wherein the task information comprises: an Input Buffer Number (IBN), an Output Buffer Number (OBN), an Input Data Size (IDS) of the task, an Output Data Size (ODS) of the task and a Device Identity (DID); and
determining that the task has met the starting condition comprises: determining that a size of data in a buffer is not smaller than the IDS, a storage space occupied by the ODS is not larger than a storage space of the buffer and the device is in an idle or configurable state.

13. The non-transitory computer storage medium according to claim 11, wherein the task information comprises: a Parameter Address (PA) and a Burst Type (BT); and
acquiring the preset parameter according to the task information, configuring the parameter to the device intended to complete the task and starting the device comprises: controlling a clock of the device intended to complete the task to be turned on, acquiring the preset parameter according to the PA, and configuring the parameter to the device intended to complete the task according to the BT, to start the device.

14. The non-transitory computer storage medium according to claim 11, wherein the task information comprises: a configuration repetition times and a PA repetition type; and the method further comprises:
repeatedly judging whether the starting condition of the task is met or not and whether the task has the highest priority or not according to the configuration repetition times, and every time when it is determined that the task has met the starting condition and the task is the task with the highest priority among the tasks which currently meet the starting condition, configuring the parameter to the device;
or, repeatedly judging whether the starting condition of the task is met or not and whether the task has the highest priority or not according to the configuration repetition times, and every time when it is determined that the task has met the starting condition and the task is the task with the highest priority among the tasks which currently meet the starting condition, reading the parameter in an address incrementing manner and configuring the read parameter to the device.

15. The non-transitory computer storage medium according to claim 11, wherein the task information comprises: Atomic TD Package (ATDP) information; and
when it is determined that the TD is an Atomic TD (ATD) in an ATDP according to the ATDP information, after configuring the parameter to the device intended to complete the task and starting the device, the method further comprises:
waiting until a task corresponding to a next ATD in the ATDP meets the starting condition, acquiring a parameter corresponding to the next ATD, configuring the acquired parameter to a device intended to complete the task and starting the device until processing of a last ATD in the ATDP is ended.
